(19) United States
(12) Patent Application Publication
(10) Pub. No.: US 2002/0113165 A1
(43) Pub. Date: Aug. 22, 2002

(54) Aircraft and control system

(76) Inventor: Michael Moshier, Los Altos Hills, CA (US)

Correspondence Address: SQUIRE, SANDERS & DEMPSEY L.L.P, 600 HANSEN WAY, PALO ALTO, CA, 94304-1043, US

(21) Appl. No.: 10/017,908

(22) Filed: Dec. 13, 2001

Related U.S. Application Data
(60) Provisional application No. 60/255,335, filed on Dec. 13, 2000.

(51) Int. Cl. B64C 1/00

(52) U.S. Cl. 244/4 A

(57) ABSTRACT

A vertical takeoff aircraft uses ducted fans for lift and propulsion. The fans are attached to an airframe and are disposed on opposite lateral sides of the aircraft. The thrust from the each of the fans may be deflected in different directions by using vanes with flaps disposed within the ducts of the fans, as well as by tilting the entire fan assemblies. This deflection of the thrust of each of the fans is used to provide control authority in pitch, roll and yaw for the aircraft under the control of a fly-by-wire system.

### REFERENCE TO RELATED APPLICATIONS

The present application claims priority benefit under 35 U.S.C. §119(e) from U.S. Provisional Application No. 60/255,335, filed Dec. 13, 2000, entitled “AIRCRAFT AND CONTROL SYSTEM” which is hereby incorporated herein in its entirety by reference.

### BACKGROUND OF THE INVENTION

1. Field of the Invention

The present invention relates to the field of manned and unmanned VTOL aircraft. More particularly, the present invention relates to control systems and techniques for manned and unmanned VTOL aircraft.

2. Description of the Related Art

As technology continues to mature, personal transportation has been an increasingly important area of research and development. Many small vehicles for transport over a variety of terrain have been developed. These include such vehicles as ATVs and dirt bikes for off-road use, snowmobiles for use in winter conditions, lightweight personal watercraft for use in the water, and a variety of subcompact cars and motorcycles for road use.

However, lightweight or other personal aerial transportation vehicles have remained scarce, and are often impractical. Many such vehicles are complex in operation and require far more maintenance than comparable land and water vehicles. Also, operation of such vehicles may be complicated and require significant training. Unlike, for example the operation of an automobile, piloting an aircraft is a skill which is specialized, complex and heavily regulated. The consequences of improper piloting are also often more severe than poor driving. Furthermore, the operation of most aerial vehicles requires specialized facilities such as airports for take-off and landing.

Although attempts have been made to produce aircraft which are small and simple enough for personal use, most previous designs have suffered from one or more of the above mentioned limitations and have not been widely accepted. Therefore, in the development of lightweight aerial transport there is a continued need for systems which are easy to use, reliable, easily operated by individuals, and/or practical for personal use.

### SUMMARY OF THE INVENTION

For purposes of summarizing, certain aspects, advantages and novel features have been described herein. It is to be understood that not necessarily all such advantages may be achieved in accordance with any particular embodiment. Thus, the systems described may be embodied or carried out in a manner that achieves or optimizes one advantage or group of advantages as taught herein without necessarily achieving other advantages as may be taught or suggested herein.

One aspect of the system described herein is a vertical take-off aircraft which has a pair of ducted fan assemblies for which are used for both lift and propulsion. The fan assemblies are disposed upon an upper portion of the airframe to either lateral side of the aircraft. Each fan assembly has a fan with a plurality of fan blades and a duct surrounding the fan. The assembly also includes control vanes which are disposed below the fan and which are movable so as to deflect the airflow blown out the bottom of the duct in different directions. By altering the direction in which the air is blown, the direction of the thrust generated by the fan assembly may be controlled.

Another aspect of the system involves the use of ducted fan assemblies as described above to produce roll, pitch and yaw control moments upon the aircraft. By directing the thrust produced by each of the fans in a forward or rearward direction, a pitch moment may be applied to the aircraft. By directing the thrust to the left or right side, a roll moment may be applied. And by directing the thrust from one fan forward and the other rearward, a yaw moment may be applied to the aircraft.

In a further aspect of the system, the separate control vanes are used to control the forward and backward deflection of the air blown out of the duct and the side to side deflection of the air blown out of the duct. In this way, a set of pitch control vanes may be used to control the pitch and yaw moments produced by the forward and backward deflection of the air, and a set of roll control vanes may be used to control the roll moments produced by the sideways deflection of the air blown out of the duct.

In yet another aspect of the system a pair of actuators are used to rotate the fan assemblies about the airframe along a lateral axis which is oriented through the fan assemblies. In this way, forward and backward deflection of the air blown by the fan assemblies may be achieved without using the control vanes described above. These actuators may be used to tilt the fan assemblies to produce pitch moments on the aircraft.

In still a further aspect of the system, a control system is used which is connected to the control vanes and/or actuators in order to drive these systems. The control system may be used to control the vanes and actuators to direct the air blown by each of the ducted fans so as to produce an appropriate overall control moment upon the aircraft. The control system may also be connected electronically to a joystick controller which is used by a pilot to indicate the roll, pitch and yaw moments that the pilot wishes to apply to the aircraft.

### BRIEF DESCRIPTION OF THE DRAWINGS

Embodiments of the invention are described in more detail below in connection with the attached drawings, which are meant to illustrate and not to limit the invention, and in which:

FIG. 1 illustrates a front view of an aircraft in accordance with one embodiment of the invention;

FIG. 2 illustrates a side view of the aircraft of FIG. 1;

FIG. 3 illustrates a rear view of the aircraft of FIG. 1;

FIG. 4 illustrates a top view of the aircraft of FIG. 1;

FIG. 5 illustrates side cut-away view of a fan assembly of the aircraft of FIG. 1;

FIG. 5A illustrates a cross-sectional view of a control vane of the fan assembly of FIG. 5 along cut line 5A-5A; and

FIG. 6 illustrates a side view of a control arm of the aircraft of FIG. 1.

### DETAILED DESCRIPTION OF THE PREFERRED EMBODIMENT

The following description and Figures describing the preferred embodiments are made to demonstrate various configurations of possible systems in accordance with the current invention. It is not intended to limit the disclosed concepts to the specified embodiments. In addition, various systems will be described in the context of an exemplary single passenger vehicle incorporating the described systems and techniques. Those of skill in the art will recognize that the techniques described are neither limited to any particular type of vehicle, nor to the use of any particular hardware for every described aspect herein.

To facilitate a complete understanding of the invention, the remainder of the detailed description describes the invention with reference to the Figures, wherein like elements are referenced with like numerals throughout.

Overview

One aspect of the system described herein involves a control system for an aerial vehicle making use of ducted fans for lift and propulsion. One example of such an aircraft is shown and described herein. A further example of such an aerial vehicle using ducted fans for lift and propulsion is illustrated and described in assignee's copending application entitled “SINGLE PASSENGER AIRCRAFT”, application Ser. No. 09/212,706, which was filed on Dec. 16, 1998, and the entirety of which is hereby incorporated by reference herein. Those of skill in the art will recognize that the techniques described are not limited to either of these particular embodiments, but rather may be applied to any vehicles making use of ducted fans for lift or propulsion.

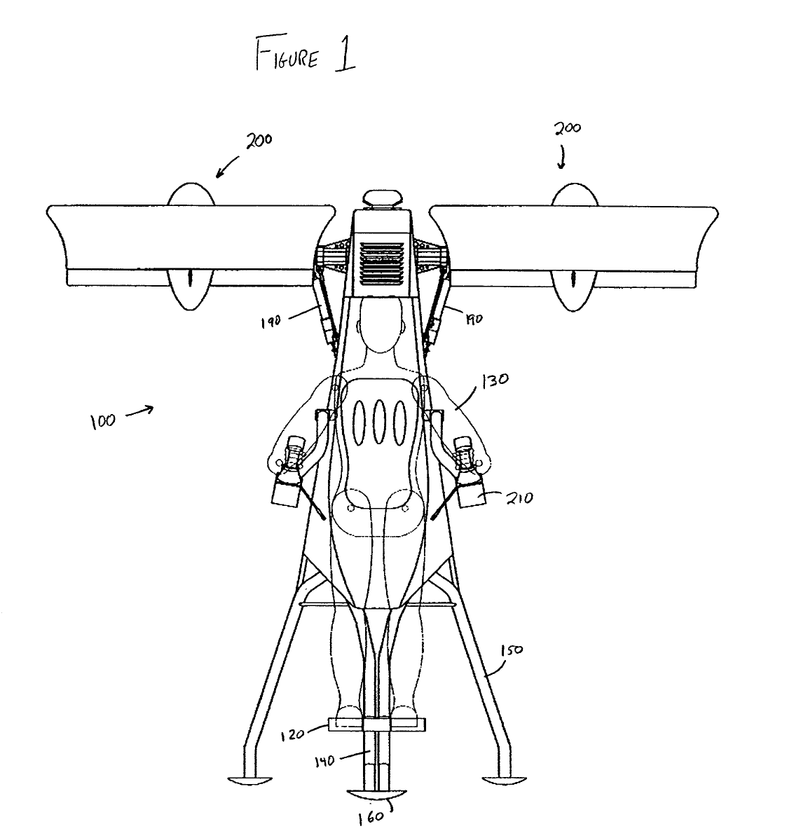

FIG. 1 shows a front view of one embodiment of a single-passenger aircraft. As can be seen in the FIGURE, the aircraft 100 comprises an airframe 110 which includes a lower platform 120 upon which a pilot 130 may stand. This platform 120 may be adjustable so that it may be positioned at a variety of vertical positions to accommodate pilots of varying height. Although the pilot 130 as shown in FIG. 1 is supported in a standing position, it will be understood that the pilot may be reclining, seated, or supported in a position other than standing in alternate embodiments of the vehicle. In some alternate embodiments, a human pilot may not even be present in the aircraft at all, piloting being handled either remotely or autonomously.

The airframe may be constructed using a variety of methods. In the embodiment illustrated, the airframe 110 may comprise a welded, tubular structure which is capable of supporting the components described herein. Appropriate materials for use in the construction of the airframe 110 include without limitation steel tubing, aluminum, carbon fiber, Kevlar and titanium. Alternate embodiments for the airframe may be constructed using a variety of materials and techniques as are known in the art. An additional example describing an alternate airframe structure may be found in assignee's copending application entitled SINGLE PASSENGER AIRCRAFT, application Ser. No. 09/212,706 referenced above.

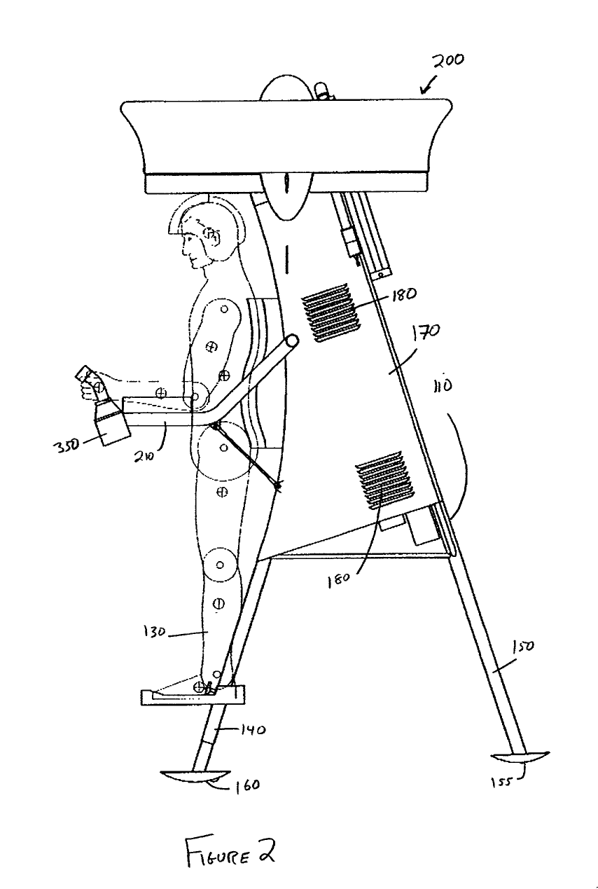

The airframe 110 also includes support structures to hold the vehicle upright while on the ground. As shown in FIG. 1, these structures may comprise three legs in a tripod configuration of landing gear as in the illustrated embodiment. One forward leg 140 is disposed on the centerline of the vehicle, and may extend in the forward direction from the airframe 110 as shown in FIG. 2. The rearward landing gear 150 may extend to either side of the centerline of the aircraft 100 and extend rearward from the airframe 110. As illustrated in FIGS. 1 and 2, the landing gear may end in a variety of devices suitable for contact with the ground. For instance, the rearward landing gear 150 may have skids or pads 155 disposed upon the lower portion of the landing gear. In an alternate embodiment, the landing gear may have wheels in order to allow for easier ground handling of the vehicle. The forward landing leg 140 may end in a broad foot 160 in order to improve stability during boarding of the vehicle and to provide additional surface area to support the weight of the aircraft 100. Additionally, the forward landing leg may incorporate a shock absorber, spring, compression struts or other mechanisms to absorb any impact produced during landing.

The airframe 110 of the vehicle defines a space behind the pilot 130 and generally above the landing gear 140, 150 which may include such aircraft systems as the engine, support electronics, a gear box or transmission, a fuel tank, and other mechanical components of the aircraft 100. The engine may comprise any appropriately sized engine, such as a piston engine, a turbine engine, an electrical motor, or any other similar powerplant. The fuel tank for such an engine may be disposed within the body at a position below the engine in one particular embodiment. Additional embodiments and details not necessary to repeat here are disclosed in assignee's copending application entitled SINGLE PASSENGER AIRCRAFT, application Ser. No. 09/212,706 referenced above.

The airframe 110 or a portion of it may be enclosed within a body or fairing 170, as shown in FIGS. 1 to 3. The fairing 170 may be made of any of a number of materials, such as sheet metal, fiberglass, composite materials, plastic or any similar materials. The fairing may also include apertures and openings to allow for access to the components within the aircraft 100, as well as to provide for portions of the vehicle which might extend beyond the space defined by the airframe 110. Vents 180 may be provided in the fairing 170 to allow air to flow into and out of the interior of the airframe. Such vents may also serve as or be connected to the intake and exhaust of the engine, if desired. The vents 180 may be seen on the front, side and rear of the fairing as shown in FIGS. 1 to 3.

The upper portion of the airframe 110 supports a pair of ducted fan assemblies 200 as shown in FIGS. 1 to 3. These ducted fan assemblies 200 are driven via drive shafts from the engine. The primary drive shaft extends upwardly from the engine inside the airframe 110 of the aircraft 100 and into a gear box located within the airframe. This gear box drives a pair of transverse shafts which extend from the gear box and out of the airframe 110 to each side. The transverse shafts extend into the ducted fan assemblies 200 and drive the fans within in opposite directions.

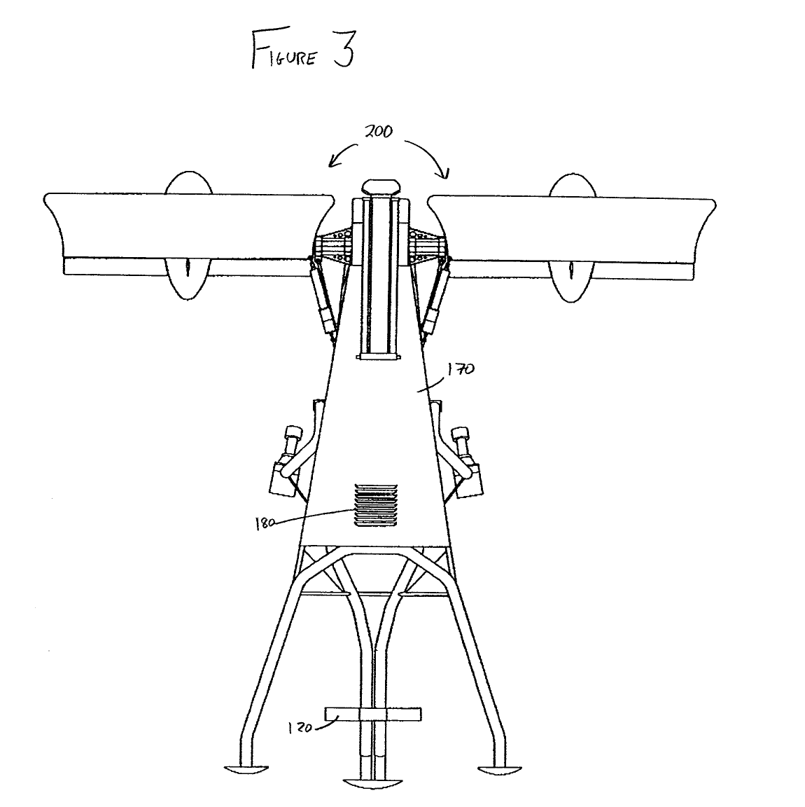

A pair of electromechanical actuators 190 also attach to the fan assemblies 200 as can be seen in FIGS. 1 and 3. In an additional embodiment, the fan assemblies 200 may be configured to fold either about their connection to the airframe 110 either upwardly or downwardly for storage. The actuators 190 and fan assemblies 200 will be discussed in greater detail below. The airframe may also contain a parachute system for emergency use. This system may be used to extract the pilot from the aircraft and lower him to the ground safely in the event of an unrecoverable failure in one embodiment. This parachute system may be configured to safely lower the entire aircraft to the ground in an alternate embodiment.

The airframe 110 of the aircraft 100 also supports a pair of arms 210 which extend forwardly from the airframe. These arms 210 extend to each side of the pilot 130 of the aircraft, and are positioned such that the arms of the pilot may reach and manipulate controls which are disposed upon the arms 210 of the aircraft. This configuration is shown most clearly in FIG. 2.

Control System

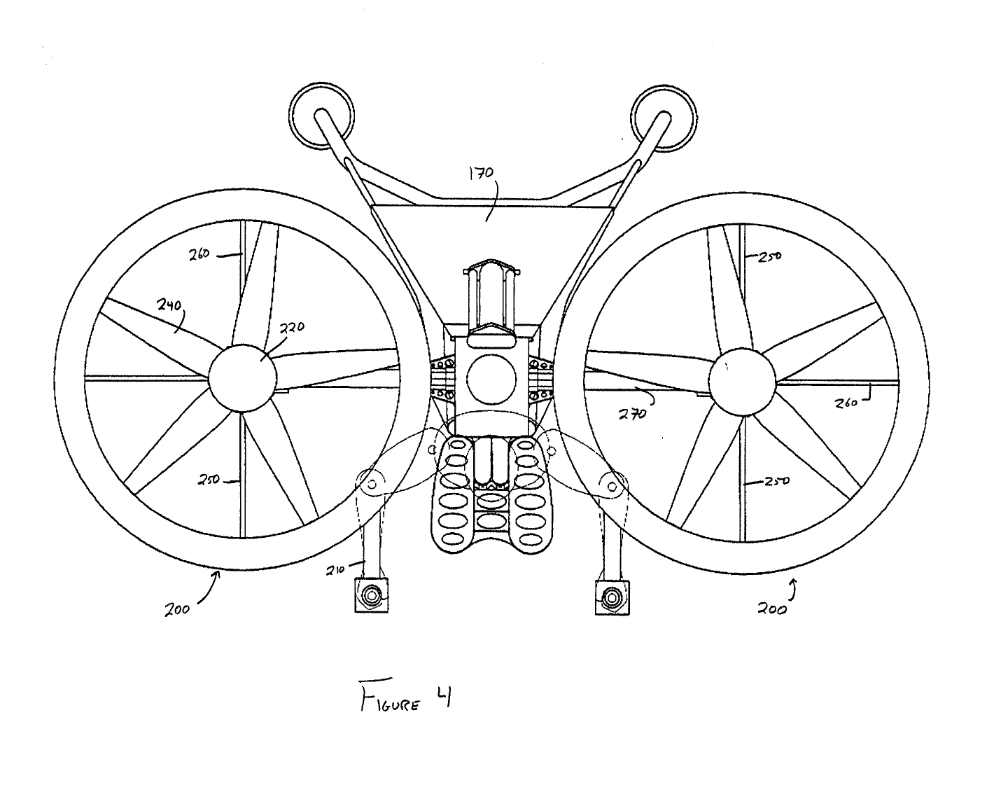

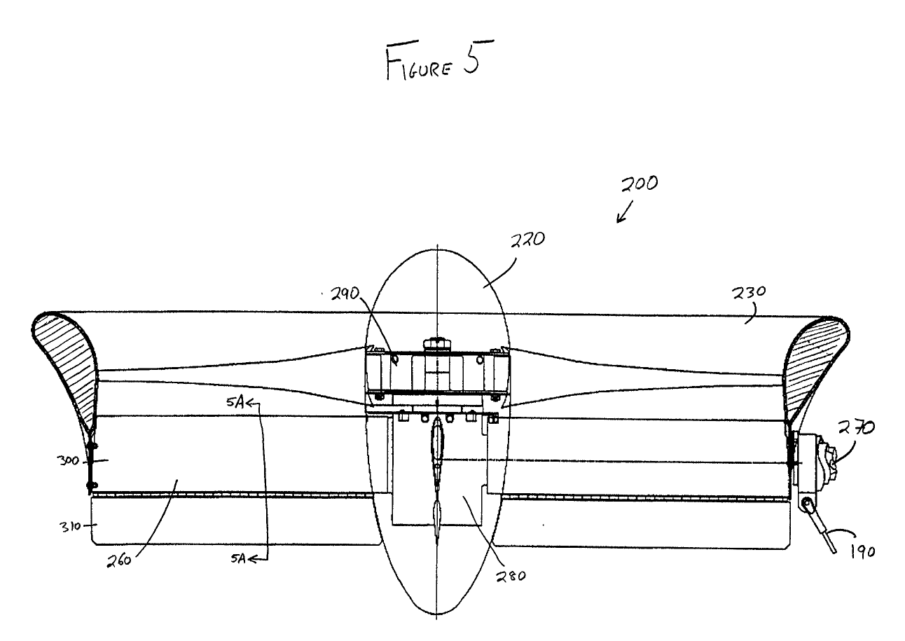

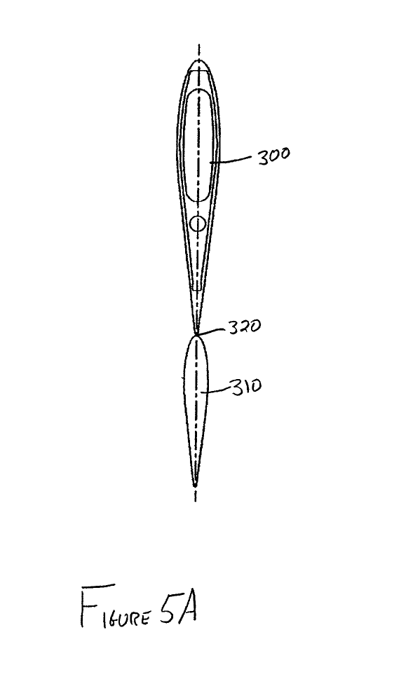

As shown in FIG. 4, one of the pair of ducted fan assemblies 200 is located to each side of the airframe 110. The fan assemblies 200 are generally symmetrical to each other, and are substantially the same in configuration apart from being disposed upon opposite sides of the airframe. Each fan assembly comprises a central housing 220, a duct 230, a fan with a plurality of blades 240, a pair of roll control vanes 250, and a at least one pitch control vane 260. A cut away view of the fan assembly 200 is shown in FIG. 5.

As shown in FIG. 5, the fan assembly 200 is supported from the side by a connection to the airframe 110 of the vehicle. The transverse shaft 270 that provides power to the fan assembly 200 enters through the side of the duct 230 and extends toward the center of the fan assembly 200 where the housing 220 is located. The housing 220 forms an enclosure which includes support structure for the fan and fan blades 240, including a gear box 280. The gear box 280 is driven by the transverse shaft 270 and is connected to the central hub 290 of the fan.

The fan blades 240 are connected to the central hub 290 and the hub rotates when the transverse shaft 270 is driven. As shown in FIG. 4, the fan blades 240 are disposed symmetrically about the hub 290 centered upon the axis of the fan assembly 200. The illustrated embodiment shows fans using five blades 240 on each fan. However, those of skill in the art will recognize that the number of fan blades 240 may be altered without changing the nature of the system presented. For example, alternate embodiments may make use of fans using between three and seven blades per fan. The blades 240 of the fans in each assembly 200 may comprise fixed pitch blades in one embodiment of the system as shown herein. However, the use of fan blades 240 with variable pitch under either automatic or pilot control may be made in alternate embodiments.

The vanes 250, 260 are located below the fan blades 240 as shown in FIG. 5. FIG. 5 illustrates only one pitch vane 260 that extends laterally from the central housing 220 toward the duct 230. Although the embodiment illustrated makes use of only a single pitch vane 260 on the outer portion of the fan assembly 200, an additional pitch vane may be disposed on the inner portion of the fan assembly in an alternate embodiment. Such a vane would be disposed on the opposite side of the housing 220 from the existing pitch vane 260, approximately in the same radial position as the incoming transverse shaft 270. The operation of an embodiment making use of an additional pitch vane is substantially similar to that described herein.

Additionally, a pair of roll vanes 250 are disposed within the duct as shown in FIG. 4. These vanes 250 are visible in FIG. 5 in profile. FIG. 5 illustrates a view of a fan assembly 200 in which a portion of the duct 230 and the central housing 220 have been cut away, making the roll vanes 250 visible. The roll vanes 250 may be disposed between the housing 220 and the duct 230 in substantially the same manner as will be described below for the pitch vane 260. In the illustrated embodiment, the pitch and roll vanes are disposed normal to one another in a cruciform arrangement about the central housing 220 of the fan assembly 200 (see FIG. 4).

The vanes 250, 260 comprise an upper portion 300 and a lower portion or flap 310. The vanes are thin, elongated blades which extend from the central housing 220 to the inner surface of the duct 230. In particular, the upper portion 300 of the vanes may be fixed with respect to the duct and the central housing, and may be used to help support the duct by connecting it to the housing 220. The flap 310 portion of the vanes is attached to the bottom of the upper portion 300 of the vane.

For instance, a hinge 320 may be disposed along the lower edge of the upper portion 300 of the vane 260. This hinge may allow the lower portion to be rotated about the hinge axis in order to produce a change in the overall cross-sectional shape of the vane 260. As may be seen in FIG. 5A, the flap 310 of the vane may be rotated so as to deflect in either a forward or rearward direction. On the roll vanes 250, the deflection of the flap 310 of the vane is in a transverse direction, either toward or away from the center of the aircraft. The motion of the flap 310 of each of the vanes may be controlled by the flight control system of the aircraft as will be described in detail below, and is accomplished using small electromechanical actuators connected to each flap 310.

Note that in an alternate embodiment, the fixed upper portion 300 of the vanes could be eliminated and the entire vane could be made movable. In such embodiments, the hinge 320 may be eliminated and the vane may be supported internally between the housing 220 and the duct and rotate about the internal support. Such a fully movable vane would operate in substantially the same manner as the two-part vanes described herein.

When the flap 310 of the vane is in the central position where it extends downwardly from the upper portion 300 of the vane, the flap 310 will not tend to deflect the flow of air being blown through the duct 230 significantly. In such circumstances, the thrust produced by the mass of air being pushed out the bottom of the duct 230 by the fan blades 240 will be vertically aligned and will tend to lift the fan assembly 200 upward. The aircraft 100 is lifted by the combined thrust from the pair of fan assemblies 200.

However, when the flap 310 of the vane is rotated away from the downward position shown in FIG. 5A, the airflow moving out of the bottom of the duct 230 will tend to be deflected in the direction in which the flap 310 is deflected. For instance, if the flap 310 of the pitch vane 260 is deflected toward the front of the duct 230, the air blown out of the duct will tend to be blown in a more forward direction, rather than straight down from the fan assembly 200. Because the thrust produced by the duct is in a direction roughly opposite to that of the direction in which the air mass exits the duct, deflecting the outward airflow toward the front of the duct rotates the thrust produced by the fan assembly 200 toward the rear of the duct. Conversely, if the flap 310 is deflected to the rear of the duct 230, the motion of the air mass is deflected toward the rear of the duct 230, and the thrust produced by the fan assembly 200 is rotated toward the front of the duct.

Note that it may be desirable in certain embodiments to mount the vanes at an angle to the vertical, rather than in a purely vertical arrangement as shown in FIG. 5A. Because the airflow downward through the duct is produced by the spinning fan, the airflow may have a lateral component in the region of the vanes. The vanes may be placed at an angle within the duct so as to be properly streamlined with the local airflow over the vanes. Although the vanes may not be in a purely vertical alignment, the operation of the system as described herein remains substantially the same.

The operation of the roll vanes 250 is substantially the same. However, because the roll vanes 250 are oriented in a fore-and-aft orientation, the motion of the flaps 310 of these vanes 250 is from side to side, rather than from front to back as in the pitch vane 260 described above. When the flaps 310 of the roll vanes 250 are deflected to the left, the airflow is deflected toward the left of the duct 230, and the thrust is deflected toward the right. When the flap 310 is deflected to the right, the thrust is therefore deflected toward the left.

In normal hovering operations or in flight conditions where there is no roll, pitch, or yaw rate, the thrust produced by each of the fan assemblies 200 will be approximately equal, directed substantially directly upward, and will be symmetrically disposed about the centerline of the aircraft. The center of gravity of the aircraft 100 is generally located at a position within the airframe 110 of the vehicle. The center of lift of the aircraft is generally located near the upper portion of the airframe between the fan assemblies 200.

It will be recognized that the center of lift may vary somewhat due to fluctuations in thrust between the two fan assemblies. However, in order to produce attitude changes in roll, pitch or yaw, the thrust may be deflected from its substantially directly upward direction. This deflection in the direction of the thrust from each of the fan assemblies 200 may be used to produce moments about the center of gravity of the vehicle to control the attitude of the vehicle in flight.

For instance, if the thrust of both of the fan assemblies 200 is deflected to the pilot's right, the aircraft 100 will tend to roll to the right. This is because even though the overall lift produced by the pair of fan assemblies 200 is the same, the lift produced by the right fan assembly will act along a line which passes closer to the center of gravity of the aircraft 100 than the lift produced by the left fan assembly. As a result, the thrust produced by the left fan assembly will act with a greater moment about the center of gravity than the thrust produced by the right fan assembly.

With the thrust from each fan assembly 200 approximately equal, this difference in the moment arms of the respective thrust vectors of the left and right fan assemblies 200 will produce a net moment on the aircraft which will tend to rotate the vehicle about its center of gravity to the right (i.e. clockwise when viewed from behind). A net lateral force to the right will also be produced, which will tend to translate the aircraft to the right when the thrust is tilted to the right from its ordinary directly upward position. The situation is reversed when the thrust is tilted to the left; a rolling moment and translation to the left will tend to occur.

Such deflection of the thrust of both fan assemblies 200 in the same direction may also be used to produce pitching moments in the aircraft 100. For instance, if the thrust of both fan assemblies 200 is tilted toward the rear of the aircraft, the aircraft will tend to pitch upward (i.e. it will tend to rotate clockwise when viewed from the pilot's left side). This is because the thrust of the aircraft will be directed along a line which passes forward of the center of gravity, producing a net moment to the rear. This will also tend to produce a rearward translation force on the aircraft as well. If the thrust of both assemblies 200 is directed to the front, the aircraft will tend to pitch downward, and a forward translation force will be produced.

Note that throughout this discussion, the thrust produced by each fan assembly 200 is generally in a direction opposite that in which the air is being blown out of the duct 230. Therefore, in order to aim the thrust of a fan assembly 200 upwardly and to the left, the air blowing out of the duct 230 will be blown downwardly and to the right.

Unlike pitch and roll which are controlled by deflecting the thrust of each fan assembly 200 in the same direction, yaw control is achieved by deflecting thrust of each fan assembly 200 in opposite longitudinal directions. For instance, if the thrust of the right fan assembly 200 is directed forward and the thrust of the left fan assembly 200 is directed rearward, the aircraft will tend to turn to the left (i.e. counter-clockwise when viewed from above). Because the longitudinal thrust of each fan assembly is acting at a distance from the center of gravity and on opposite sides of the center of gravity, the result is a net moment about the vertical (yaw) axis for the vehicle. No net translation force is produced when the thrust of the fan assemblies is deflected differentially for yaw control. In the same manner as described above, a yaw to the right will be produced if the thrust from the left fan assembly 200 is tilted forward and the thrust from the right fan assembly is tilted rearward.

Although as described above, the tilting of the thrust from the fan assemblies 200 may be used to produce control moments in the pitch, roll and yaw directions, the overall thrust produced by the fan assemblies 200 will still be predominantly upward. This allows for the thrust of the fan assemblies to continue to support the weight of the aircraft, even as a the thrust is tilted to produce components of the thrust which act in the lateral and longitudinal directions in order to control the attitude of the aircraft.

Although the system as shown and described herein makes use of a pair of roll vanes 250 and a single pitch vane 260 in a cruciform configuration for each fan assembly 200, other arrangements may also be effective. As mentioned above, a second pitch vane could be added to the inboard portion of the fan assembly. Similarly, there is no need to limit the vanes to operating in a single axis of either pitch or roll. (Note that yaw is controlled by differential application of the pitch vanes.) Systems using vanes disposed at positions located 45, 135, 225 and 315 degrees away from the front of the duct 230 may also be used. Although the correspondence between the pilot controls (described below) and the individual vanes may differ from what is described below, any system which allows the deflection of the air mass blown out of the duct 230 may serve to produce the same sort of aircraft control system as described above.

For the roll, pitch, and yaw control discussed above, the deflection of the air blown out of the ducts 230 is accomplished by the action of the vanes 250, 260 within the fan assembly 200 without altering the orientation of the fan assembly 200 with respect to the airframe 110 of the aircraft 100. However, it is also possible to deflect the thrust produced by the fan assemblies 200 by tilting the entire fan assembly with respect to the airframe 110. In particular, the fan assemblies may be rotated about a lateral axis located generally along the axis of the transverse shaft 270. Such rotation allows for the tilting of the entire assembly to the front and to the rear. Such motion allows for the direction of thrust produced by each fan assembly 200 to be altered in substantially the same direction as that produced by the action of the pitch vanes 260 described above.

Although such tilting of the ducts makes possible both pitch and yaw control of the vehicle without the use of the longitudinal vanes 260, it may be advantageous to use such deflection of the fan assembly 200 as a trim function to simplify control of the aircraft. This will be further discussed below. The tilting of each fan assembly as a whole is performed by an electromechanical actuator connected to the side of each fan assembly 200.

Pilot Controls

The description above explains how the operation of flaps 310 and tilting fan assemblies 200 produce actual control moments on the aircraft 100. The operation of the flaps and tilt of the fan assemblies are carried out via electromechanical actuators 190 disposed on the airframe 110 and within the center housing 220 of each duct 230. The movement of each actuator is determined based upon control inputs by a pilot 130. In the embodiment shown, the control of the actuators is handled by a control system which electronically commands the appropriate amounts of deflection and tilt of each flap and fan assembly based upon the control inputs. This fly-by-wire system relies upon electrical signals to sense the control inputs made by the pilot to the flight controls (discussed below), and then determines the amount of deflection to be made in each control surface (vane or tiltable fan assembly) to carry out the command the control input represents.

Such a fly-by-wire system eliminates the need for mechanical linkages between the flight controls operated by the pilot and the control surfaces themselves. Furthermore, the fly-by-wire system may include logic which helps prevent inadvertent over-controlling of the aircraft or producing unintentionally unstable flight modes. Although alternate embodiments may make use of a mechanically linked control system (see for example assignee's copending application entitled SINGLE PASSENGER AIRCRAFT, application Ser. No. 09/212,706 referenced above), the discussion herein will focus upon the fly-by-wire electronic flight control system.

It should also be noted that the following discussion of control systems will be made with reference to the controls as they would be manipulated by a pilot 130 riding upon the vehicle as shown in FIGS. 1 and 2. However, the application of these control techniques need not be limited to a pilot 130 actually located on the vehicle. A remotely located pilot could use the same techniques to pilot the aircraft via a radio frequency or other remote command link in one alternate embodiment. Similarly, in another alternate embodiment, a pre-programmed flight computer may command the control systems described above. In each case, the commands from either an onboard pilot, a remote pilot, or an autonomous flight computer may be fed to the fly-by-wire control system, and the vehicle operated using the techniques described herein.

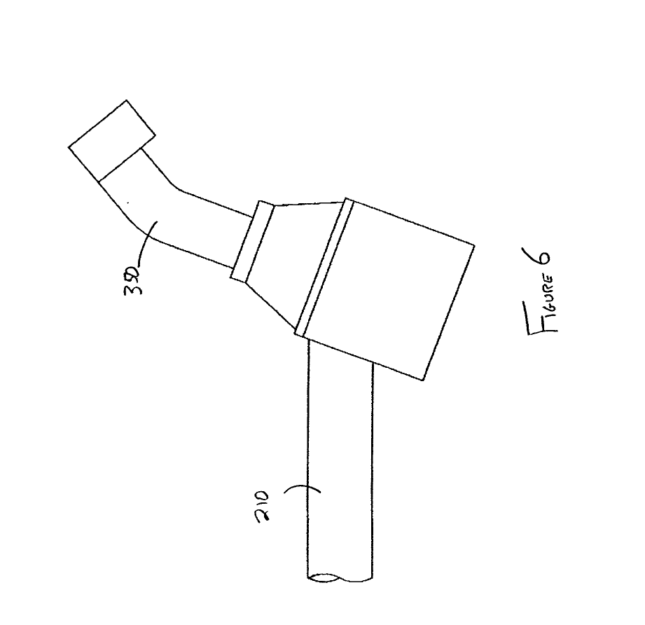

As discussed above, a pair of arms 210 extend from the side of the airframe 110 in the embodiment shown in FIGS. 1 to 3. The arms 210 are fixed in position with respect to the airframe 110 and incorporate a hand controller such as a joystick 350 on each arm 210 as shown in FIG. 6. During flight, the pilot 130 will stand upon the platform 120 and place his arms along the arms 210 of the aircraft with his hands in a position to manipulate the joysticks 350. Although there may be other controls disposed upon the aircraft, primary flight control is carried out by the pilot 130 using the pair of joysticks disposed upon the arms 210 of the aircraft.

The left and right joysticks 350 provide different control inputs and perform different functions from one another and will be described below. It should be noted that although a particular embodiment will be described, the functions performed by each joystick may be reversed or mixed and matched without altering the overall nature of the system described herein.

The left hand joystick 350 is used to control the overall level of thrust produced by the fan assemblies 200 of the aircraft. The forward and backward axis of this joystick 350 is used to control the engine throttle. Pushing the joystick 350 forward decreases engine throttle, while pulling it back increases engine throttle. The power produced by the engine increases with increased throttle, and the increased power increases the RPM of the fans, increasing the thrust of each fan assembly 200. As described above, both fan assemblies 200 are driven by the engine through the same main gear box and separate but identical gear boxes 280 in each fan assembly 200. As a result, both fans operate with the same RPM and therefore produce approximately the same thrust in response to any change in throttle control via the joystick 350.

In particular, the amount of thrust produced by the vehicle is directly responsible for the rate at which the vehicle climbs or descends. Because the thrust is the only force used to counteract the weight of the vehicle, if the vertical thrust is less than the weight of the vehicle, the vehicle will accelerate downwards. If the vertical thrust is greater than the weight of the aircraft 100, the aircraft will accelerate upwards. By adjusting the overall throttle, the pilot 130 may adjust the rate at which the aircraft climbs or descends during flight.

In addition to forward and back motion of the joystick 350, a thumb switch may also be provided upon the joystick 350 to access a trim function for the throttle. The trim switch may be used to make fine control adjustments to the throttle without moving the joystick 350 itself. While the motion of the joystick 350 may be used to adjust gross thrust, the trim switch may be used to adjust fine thrust. Such settings allow a pilot or other controller to keep the aircraft flying at a consistent altitude, for example, without having to adjust the gross throttle setting.

In alternate embodiments, additional mechanisms for adjusting the thrust of each fan assembly 200 may be included on the aircraft. These may include without limitation spoilers, variable pitch fan blades, louvres attached to the duct, variable geometry ducts and similar systems to alter the overall amount of lift produced by the fan assembly. The control of any or all of these systems may be linked to the trim or gross control inputs in order to more effectively command the aircraft.

The right hand joystick 350 provides command inputs for the roll, pitch and yaw axes of the aircraft 100. The right hand joystick may be moved in three different axes. The joystick may be moved forward and backward, it may be moved from side to side, and it may be twisted. These motions of the joystick 350 correspond generally to the moment applied to the aircraft by each of these motions. In particular, the forward and backward motion of the joystick controls pitch moments applied to the aircraft, the side to side motion controls the roll moment applied to the aircraft, and the twisting motion controls the yaw moment applied to the aircraft.

For example, as the right joystick 350 is pushed forward, the flight control system will detect this motion and command the pitch vanes 260 to deflect rearwardly in order to produce a forward pitching moment on the aircraft (counter-clockwise when viewed from the pilot's left). The amount of motion of the joystick will correspond to the magnitude of the moment applied to the aircraft, although this relationship need not be linear. In particular, it may be beneficial to provide a region of reduced sensitivity near the center of the range of motion of the joystick 350. This allows for more precise control inputs to be made when using the joystick 350 near its center region. Conversely to what is described above for forward motion, a rearward motion of the right joystick will result in a backward pitching moment on the aircraft brought about by a forward deflection of the pitch vanes 260.

The side to side motion of the right joystick sends messages to the flight control system to command the deflection of the roll vanes. When the joystick is pushed to the left, the flight control system detects the motion of the joystick and sends signals to the roll vanes to deflect to the right, causing the aircraft to experience a rolling moment to the left as described above. Pushing the stick to the right results in a rolling moment to the right.

Twisting the right joystick 350 results in a yaw command being sent to the flight control system. In order to effect a yaw moment, the flight control system commands a forward deflection of one pitch vane and a rearward deflection of the other. In this way twisting the joystick 350 to the left (counter-clockwise when seen from above) causes a yaw moment to the left to be applied to the aircraft. Twisting the joystick to the right produces a rightward yaw moment on the aircraft.

Note that these control inputs may be combined and used simultaneously. For instance, if the right hand joystick is twisted to the left, pushed to the left and pulled back simultaneously, the flight control system will adjust the various vanes to produce a roll moment to the left, a yaw moment to the left, and an upward pitching moment. Because the pitch vanes in particular are used to produce both pitch and yaw moments, the flight control system may use a variety of techniques to properly execute combined pitch and yaw maneuvers.

In one embodiment, the commands to the various actuators generated by the control inputs may be simply summed. For instance, if the combination discussed above is commanded, the left yaw will command a rearward deflection of the pitch vane in the right fan assembly. The upward pitch will command a forward deflection of the pitch vane in the right fan assembly. When summed, the right pitch vane may stay roughly centered. In contrast, upward pitch and left yaw both command a forward deflection of the pitch vane in the left fan assembly, so the left pitch vane will deflect farther than would be required by either the yaw or pitch commands alone.

Such control operations carried out within the flight control system may be handled by a variety of digital or analog control means. These may include various amplification circuits driving analog control inputs to the various actuators in one embodiment. Alternate embodiments may use a properly programmed digital computer to read the various inputs and calculate the appropriate outputs to produce. The flight control system may also be programmed to take into account such non-pilot commanded factors such as current velocity and attitude when determining the appropriate level of deflections to command in the various vanes.

For instance, in one embodiment, a gyro system may be included which feeds information to the flight control system. The gyro system may provide information on the current attitude of the aircraft, as well as the current roll, pitch and yaw rates. This information may be used to determine how effective the commanded deflections of the vanes and tilt of the fan assemblies are in producing the moments commanded by the pilot. This information may also be used to prevent the input from the pilot from commanding moments that result in unsafe flying conditions in another embodiment.

It should also be noted that the control joysticks need not actually move to be effective as input devices. In an alternate embodiment, the joysticks 350 may be rigidly mounted in position upon the arms 210 of the aircraft, and outfitted with strain gauges in order to detect the amount of force being applied to the joystick along each axis. This signal may then be sent to the flight control system just as a position or deflection signal might be sent in the case of an actual movable joystick.

By applying control forces to the pair of joysticks 350, the pilot is able to command a variety of attitude changes for the aircraft, as well as producing appropriate translational forces when roll or pitch moments are applied. In general, as long as the a control input is made and the flaps 310 are deflected, the vehicle will continue to pitch, roll, or yaw in the commanded direction until opposing, stabilizing aerodynamic forces equal the control forces. In this way, the pilot may command the aircraft to hover, move forward or backward, slide to either side, spin about its own axis, perform coordinated turns using both roll and yaw, and perform similar maneuvers to conventional helicopters or other aircraft.

Similar to the trim function described above for the throttle control on the left joystick, the right joystick may include trim functions for the roll, pitch and yaw axes as well. In one embodiment, the trim switches may comprise thumb operated switches disposed upon the right joystick 350 which may be pushed in either direction. For instance, roll trim may be controlled via a switch on the joystick which may be pushed to the left or right. Pushing this switch to the left sends a command to the flight control system to increase the amount of left roll commanded, while pushing it to the right would increase the amount of right roll commanded. Unlike the commands made via the gross sideways forces on the joystick, the roll command produced by the roll trim switch remains in effect even after the trim switch is released and the joystick 350 is moved back to the center position.

In this way, a trim switch may be used to compensate for slight unbalances produced during operation of the aircraft without requiring constant control input via the stick. For instance, if the loading of the aircraft is such that the center of gravity is off-center, this will require a small constant roll to one side in order to keep the aircraft properly upright when flying. Without the trim function, a constant sideways pressure on the control stick would be required by the pilot. Maintaining and modulating this pressure may be fatiguing to the pilot and in general adds to the pilot work load. By simply allowing the pilot to apply additional roll trim until the aircraft is properly balanced, the pilot can then fly the aircraft without having to manually compensate for the roll imbalance.

Yaw trim may be controlled using another side-to-side trim switch in essentially the same way. This switch may be located on the front or top of the joystick for operation by either the thumb or forefinger of the pilot's right hand. However, instead of producing incremental levels of roll command, yaw command will be produced. In an alternate embodiment, yaw trim may be handled by a dial or knob disposed upon the right joystick. In either embodiment, the position of the yaw trim input is detected and sent to the flight control system for processing in essentially the same manner as described above for the roll trim system.

A pitch trim control may be located upon the joystick in essentially the same manner as the roll trim switch. In an alternate embodiment, the pitch and roll trim switches may be combined into a four-way thumb switch disposed upon the top or back of the right joystick 350. Although pitch control may be handled in precisely the same manner as described above for roll control, the pitch trim may also be used to command the actuators 190 that control the gross tilt of the fan assemblies 200.

As discussed above, the fan assemblies 200 may be tilted about the axis of the transverse shaft 270 by the electromechanical actuators 190 at the top of the airframe 110. This tilting of the fan assemblies 200 produces the same sort of deflection of the thrust that may be produced by deflecting the pitch vanes 260 without actually deflecting the vanes at all. In one embodiment, the pitch trim function may be linked directly to the tilt of the fan assemblies 200, rather than to an incremental control over the pitch vanes 260. Such a feature is particularly beneficial for pitch, as opposed to roll or yaw, in that a forward pitching motion is used to produce forward flight of the aircraft 100. Especially for high speed flight, it may be desirable that the fan assemblies 200 be tilted forward to produce sufficient moment to maintain the attitude needed to sustain such speed.

By allowing the aircraft to be trimmed into a forward position by tilting the fans, the aircraft may be placed into a mode in which steady forward motion is produced without requiring constant forward pressure on the right control joystick by the pilot. The continuous pitching moment produced by such trim offsets the aerodynamic pitching moment created by forward motion of the aircraft, allowing the aircraft to maintain a stable attitude and fly at a constant speed.

The combination of the systems described above for fly-by-wire control and control input by the pilot using the pair of joysticks 350 disposed upon the arms 210 of the aircraft allow for effective control of the aircraft. In general, the pilot's left hand commands the magnitude of the thrust vectors produced by the fan assemblies 200 while the pilot's right hand commands the magnitude of the pitch, roll and yaw moments applied to the vehicle.

In addition to the mode of operation described above, alternate embodiments of the control system may provide for additional ways to coordinate the operation of the various control systems to produce effective flight control. In one such embodiment, the functions provided by the pitch vanes and the tilting fan assemblies are combined such that the pilot need not be concerned with which of the two control techniques are being used to provide pitch authority at any given time.

For example, in the embodiment described above, the trim switch may be used to manually force the tilt of the fan assemblies 200 in order to produce forward and backward trim in pitch and translation. At the same time, the deflection of the pitch vanes may be commanded by the forces applied to the right control joystick 350 itself to produce pitch control moments. However, the pilot must choose which of the two systems to use to produce pitching moments at any given time. In particular this can be problematic if the pilot inadvertently trims the aircraft into a strongly pitched configuration and then attempts to countermand this pitch using the joystick itself. The two systems, vanes and fan tilt, will work against each other, reducing the efficiency of the fan assembly, and possibly preventing effective control moments from being applied.

However, the flight control system may be programmed to incorporate the operation of both the tilt of the fan assemblies 200 and the deflection of the pitch vanes 260 into its system for controlling the overall pitch moment on the aircraft. Using such a technique, the flight control system will treat the joystick pitch command as a rapid, gross input and the trim pitch command as a steady, incremental input. Based on these control inputs, the system will then produce the commanded level of pitch using whatever combination of fan tilt and flap deflection that is appropriate at that instant. This reduces the possibility of over-trimming the aircraft in pitch such that sufficient pitch authority to overcome the pitch trim is not available using the joystick. It also allows for the aircraft to make the most control authority available to the pilot in pitch at all times.

As an example, if the pilot is flying the aircraft forward by maintaining a steady forward pressure on the right joystick, the aircraft will initially deflect the appropriate flaps on the pitch vanes, and the aircraft will begin to move forward. If the pilot holds this position without using trim, the flight control system may begin to reduce the amount of vane flap deflection and simultaneously increase the amount of forward fan tilt to maintain a constant pitch moment. In this way, if the pilot requires a sudden additional pitching moment, the full control authority of the vanes may be made instantly available.

In another alternate mode of operation, the aircraft may have the flight control system configured to adjust the tilt of the fan assemblies 200 in order to compensate for changes in attitude such that the thrust is always maintained over the center of gravity of the aircraft to the largest degree possible. In such modes, the fan assemblies 200 will tend to rotate so that they maintain a fairly constant position relative to a horizontal axis, rather than relative to the airframe 110. This mode may be particularly useful during takeoff and landing operations. Because the aircraft will tend to take off and land vertically, it is generally undesirable for there to be any forward and back motion of the vehicle during these maneuvers. By maintaining the orientation of the fan assemblies relative to the horizontal, the amount of forward and aft motion of the vehicle which is produced by perturbations may be minimized.

The various embodiments of aircraft and control systems described above thus provide a number of ways to provide a lightweight vertical takeoff aircraft powered by ducted fans. In addition, the techniques described may be broadly applied across a variety of aircraft, both manned and unmanned, and may be used with designs making use of different powerplant and airframe designs.

Of course, it is to be understood that not necessarily all such objectives or advantages may be achieved in accordance with any particular embodiment using the systems described herein. Thus, for example, those skilled in the art will recognize that the systems may be developed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments. For example, the additional flight modes to maintain maximum control authority in pitch discussed above may be combined with systems making use of different vane configurations within the duct. Similarly, the various control techniques and command systems discussed above, as well as other known equivalents for each such feature, can be mixed and matched by one of ordinary skill in this art to construct aircraft using ducted fans for lift and propulsion in accordance with principles of the system described herein.

Although this techniques and systems have been disclosed in the context of certain embodiments and examples, it will be understood by those skilled in the art that these techniques and systems may be extended beyond the specifically disclosed embodiments to other alternative embodiments and/or uses and obvious modifications and equivalents thereof. Thus, it is intended that the scope of the systems disclosed herein disclosed should not be limited by the particular disclosed embodiments described above, but should be determined only by the scope of the claims that follow.

What is claimed is:

1. A vertical take-off aircraft comprising:
an airframe;
a pair of ducted fan assemblies movably mounted on opposite sides of the airframe, each ducted fan assembly comprising a duct, a fan with a plurality of fan blades disposed within the duct, and one or more control vanes mounted upon the duct below the fan in a cruciform configuration, the control vanes being at least partially movable so as to controllably deflect the airflow out of the bottom each of the pair of ducted fan assemblies;
a pair of actuators mounted between the airframe and each of the pair of ducted fan assemblies, the actuators configured to rotate each of the pair of ducted fan assemblies about a lateral axis through each of the pair of ducted fan assemblies; and
a control system connected to the pair of actuators and the control vanes, the control system configured to drive the actuators and control vanes to produce changes in the direction of the airflow out of the bottom of each of the pair of ducted fan assemblies, such changes in airflow direction being used to control the attitude of the aircraft.

2. The aircraft of claim 1 further comprising at least one joystick, the joystick being connected to the control system electronically and configured to send signals representing the forces applied to the joystick to the control system, the control system being configured to use the signals to determine how to drive the actuators and control vanes.

3. The aircraft of claim 2 wherein the joystick further comprises a trim switch, the trim switch being connected to the control system electronically and the control system is further configured to drive the actuators in response to the pressure upon the trim switch.

4. The aircraft of claim 1 wherein the pair of ducted fan assemblies are configured to fold about a longitudinal axis relative to the airframe.

5. A vertical take-off aircraft comprising:
an airframe;
a pair of ducted fan assemblies movably mounted on opposite sides of the airframe, each ducted fan assembly comprising a duct, a central housing and a fan with a plurality of fan blades disposed within the duct;
at least one pair of pitch control vanes, one of the at least one pair of pitch control vanes disposed within each of the pair of ducted fan assemblies and extending laterally between the central housing and the duct, the pitch control vanes being at least partially movable in a forward-and-aft direction so as to controllably deflect the airflow out of the bottom of each of the pair of ducted fan assemblies from front to back;
two pairs of roll control vanes, one pair of roll control vanes disposed within each of the pair of ducted fan assemblies and extending longitudinally between the central housing and the duct, each pair of roll control vanes being at least partially movable in a side-to-side direction so as to controllably deflect the airflow out of the bottom of each of the pair of ducted fan assemblies from side to side; and
a control system connected to the pitch and roll control vanes, the control system configured to drive the pitch and roll control vanes in order to control the direction of the airflow out of the bottom of each of the pair of ducted fan assemblies, the control system driving the pitch control vanes in the same direction to control the pitch of the aircraft, the control system driving the roll control vanes in the same direction to control the roll of the aircraft, and the control system driving the pitch control vanes in opposite directions to control the yaw of the aircraft.

6. The aircraft of claim 5 further comprising a pair of actuators mounted on the airframe and attached to each of the pair of ducted fan assemblies, the actuators configured to rotate each of the pair of ducted fan assemblies about a lateral axis through each of the pair of ducted fan assemblies.

7. The aircraft of claim 6 further comprising at least one joystick, the joystick being connected to the control system electronically and configured to send signals representing the forces applied to the joystick to the control system, the control system being configured to use the signals to determine how to drive the pitch and roll control vanes.

8. The aircraft of claim 7 wherein the joystick further comprises a trim switch, the trim switch being connected to the control system electronically and the control system is further configured to drive the actuators in response to the pressure upon the trim switch.

9. A vertical take-off aircraft comprising:
an airframe comprising three landing legs and a platform upon which a pilot is supported in a standing position;
a pair of ducted fan assemblies mounted on opposite sides of the airframe and rotatably attached to the airframe at an upper portion of the airframe such that each of the pair of ducted fan assemblies may be rotated about a lateral axis through the fan assembly, each ducted fan assembly comprising a duct, a fan with a plurality of fan blades disposed within the duct, and one or more control vanes mounted upon the duct below the fan in a cruciform configuration, the control vanes being at least partially movable so as to controllably deflect the airflow out of the bottom each of the pair of ducted fan assemblies;
a pair of actuators mounted on the airframe and one of the pair of actuators attached to each of the pair of ducted fan assemblies, each of the actuators configured to rotate one of the pair of ducted fan assemblies about a lateral axis through the ducted fan assembly; and
a control system connected to the pair of actuators and the control vanes, the control system configured to drive the actuators and control vanes to produce changes in the direction of the airflow out of each of the pair of ducted fan assemblies.

10. The aircraft of claim 9 wherein the one or more control vanes comprise a laterally disposed pitch control vane and a longitudinal roll control vane.

11. The aircraft of claim 9 wherein the is configured to drive the pitch control vanes in the same direction to control the pitch of the aircraft, the control system is configured to drive the roll control vanes in the same direction to control the roll of the aircraft, and the control system is configured to drive the pitch control vanes in opposite directions to control the yaw of the aircraft.

12. A control system for use in a vertical take-off aircraft comprising a pair of ducted fan assemblies disposed on opposite sides of an airframe, the control system comprising:
a pair of pitch control vanes, one of the pair of pitch control vanes disposed within each of a pair of ducted fan assemblies, the pitch control vane extending laterally within a duct of the ducted fan assembly and being at least partially movable in a longitudinal direction;
a pair of roll control vanes, one of the pair of roll control vanes disposed within each of the pair of ducted fan assemblies, the roll control vane extending longitudinally within the duct of the ducted fan assembly and being at least partially movable in a lateral direction; and
a controller connected to the pitch and roll control vanes, the controller configured to drive the pitch and roll control vanes in order to control the direction of the airflow out of the bottom of each of the pair of ducted fan assemblies, the control system driving the pitch control vanes in the same direction to control the pitch of the aircraft, the control system driving the roll control vanes in the same direction to control the roll of the aircraft, and the control system driving the pitch control vanes in opposite directions to control the yaw of the aircraft.

13. The control system of claim 12 wherein the controller receives input from a joystick connected to the controller electronically and configured to send signals representing the forces applied to the joystick to the controller, the controller being further configured to use the signals to determine how to drive the pitch and roll control vanes.

14. The control system of claim 14 wherein the pitch control vane and roll control vane are oriented normally to one another within the duct.

15. The control system of claim 14 further comprising a pair of actuators connected to the pair of ducted fan assemblies, the actuators configured to rotate the pair of ducted fan assemblies about a lateral axis through the ducted fan assembly.

16. The control system of claim 15 wherein the controller is further configured to drive the actuators in the same direction to control the pitch of the aircraft.

17. The control system of claim 15 wherein the joystick comprises a trim switch, the trim switch being connected to the controller electronically and the controller is further configured to drive the actuators in response to the pressure upon the trim switch.

18. A vertical take-off aircraft comprising:
an airframe;
a pair of ducted fan means for producing thrust disposed upon opposite sides of the airframe;
vane means for altering the direction of the airflow out of the duct;
tilting means for altering the orientation of the pair of ducted fan means relative to the airframe; and
control system means for driving the control vane means and tilting means.

19. The aircraft of claim 18 wherein the control system means is connected to a joystick configured to send signals representing the forces applied to the joystick to the control system means and the control system means is configured to receive signals from the joystick and is further configured to use the signals to determine how to drive the vane means and tilting means.
